(19) United States
(12) Patent Application Publication
(10) Pub. No.: US 2006/0079730 A1
(43) Pub. Date: Apr. 13, 2006

(54) Cover for infant incubator

(76) Inventor: Jane M. Getsla, San Lorenzo, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/250,559

(22) Filed: Oct. 13, 2005

Related U.S. Application Data
(60) Provisional application No. 60/618,636, filed on Oct. 13, 2004.

(51) Int. Cl. A61G 11/00

(52) U.S. Cl. 600/22

(57) ABSTRACT

An infant incubator cover has a coverable opening located through the top portion of the incubator cover. A cover panel is locatable over the opening to allow the user to cover and uncover the opening. The incubator cover may be held in place by using straps or bands to securely fasten the cover to the incubator, while allowing the panel to be removed or folded back to allow access to the infant.

### CROSS REFERENCE TO OTHER APPLICATIONS

This application claims the benefit of U.S. provisional patent application Ser. No. 60/618,636, filed Oct. 13, 2004, which is hereby incorporated by reference in its entirety.

### FIELD OF INVENTION

The present invention relates generally to covers for infant incubators. More particularly, it relates to a cover having an access opening in an upper portion to allow for viewing and/or treatment of the infant in the incubator without the need for removal of the cover.

### BACKGROUND OF THE INVENTION

Babies that are born prematurely are often placed in an incubator for short or longer periods of time. This allows monitoring of the infant, while providing an enclosed environment. Recent thinking has suggested that placing a cover over the incubator to darken the environment and muffle sounds allows the infant an environment more closely resembling the womb during these early days, thereby potentially reducing the stress and shock during this time period. The cover may be placed over the incubator full time or used intermittently to simulate the day/night pattern. In some cases, infants need treatment, such as light treatment for jaundice and/or other therapies that require that the cover be removed. The infant may also be visually inspected to determine the infant's status, including respiratory function, coloration, awake, asleep, grimace, etc. Further physical access to the infant may be needed to feel the infant's skin for perspiration, apply topical treatments or otherwise physically interact with the infant. However, current covers are fairly large and unwieldy, which can make difficult the installation and removal of the cover. Further the cover should be kept clean and free of contamination and therefore, needs to be placed on a clean surface during the time the cover is removed.

Therefore, there is a need in the industry to provide an incubator cover, which solves these unanswered needs.

### SUMMARY OF THE INVENTION

The present invention takes the form of an incubator cover, which has a coverable access opening, located through the top portion of the incubator cover. The access opening may be uncovered to provide light, visual and/or physical access to the infant in the incubator without necessitating the removal of the entire cover. Once the treatment is complete, a cover panel is located over the access opening to provide a fully darkened and enclosed environment. Some configurations of the incubator cover are sufficient to hold the incubator cover in place over the incubator without additional support or attachment. In other configurations, the incubator cover may be held in place by using straps or bands, such as twill tape or ribbon, to securely fasten the cover to the incubator. In all of the embodiments the body portion of the incubator cover may remain in place while allowing the panel to be removed or folded back to allow visual and/or physical access to the infant.

One embodiment of the invention is an incubator cover for covering an infant incubator containing an infant, including: a flexible incubator cover body, an access opening formed in the cover body, the access opening located to allow access to an infant located within the infant incubator, and a cover panel sized and configured to cover the access opening, wherein the cover panel has an open position in which the access opening is visible and a covering position in which the access opening is entirely covered.

Other embodiments may include several additional features. The cover panel may be permanently or detachably attached to the cover body. The incubator cover may include one or more straps that rest across the top surface of the incubator. The incubator cover may include one or more straps that wrap around a portion of the incubator to secure it thereto.

A method of using the incubator cover includes the steps of: (a) placing an infant in an incubator, (b) covering at least an upper portion of the incubator with a flexible incubator cover having a body and a cover panel, (c) adjusting the cover panel of said incubator cover to reveal an access opening and (d) readjusting the cover panel to cover said access opening.

Other objects and advantages of the invention will no doubt occur to those skilled in the art upon reading and understanding the following detailed description along with the accompanying drawings.

### BRIEF DESCRIPTION OF THE DRAWINGS

FIG. 1 is a front view of a first embodiment of the incubator cover shown over an incubator.

FIG. 2 is a back view of the incubator cover shown in FIG. 1.

FIG. 3 is a front view of the incubator cover of FIG. 1 with the cover panels folded away from the access opening.

FIG. 4 is a front perspective view of a second embodiment of the incubator cover shown over a different model of incubator.

FIG. 5 is a front perspective view of the incubator cover of FIG. 4 with a portion of the cover panel folded down.

FIG. 6 is a front perspective view of the incubator cover of FIG. 4 with the cover panel folded down.

FIG. 7 is a perspective view of a third embodiment of the incubator cover shown on a third model of incubator.

FIG. 8 shows a view of the incubator cover of FIG. 7 with the cover panel folded away from the access opening.

### DETAILED DESCRIPTION OF THE INVENTION

In general, the present invention is an incubator cover, which has a coverable access opening located through the top portion of the incubator cover. Typically, when the incubator cover is in place on the incubator, most or all of the access opening will be generally horizontal, i.e. parallel to the floor and ceiling. Although an alternate version of the incubator cover would be created with a non-horizontal opening, if the top of the incubator is sloped, such as seen in Example 2 discussed below. The access opening may expose all or part of the top surface of the incubator. A cover panel is designed to cover the access opening. The cover panel may be designed to be fully detachable or it may be permanently attached.

The access opening may be uncovered to provide light, visual and/or physical access to the infant in the incubator without necessitating the removal of the entire incubator cover. Once the treatment is complete, a cover panel is replaced over the access opening to provide a fully darkened and enclosed environment.

Some configurations of the incubator cover are sufficient to hold the incubator cover in place over the incubator without additional support or attachment. In other configurations, the incubator cover may be held in place by using straps or bands, such as twill tape or ribbon, to securely fasten the cover to the incubator. In all of the embodiments the body portion of the incubator cover may remain in place while allowing the cover panel to be removed or folded back to allow visual and/or physical access to the infant.

### EXAMPLE 1

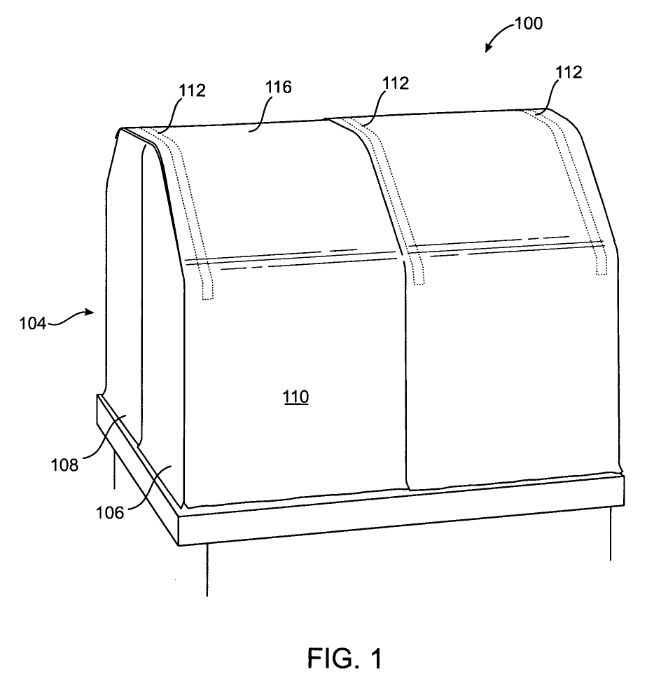

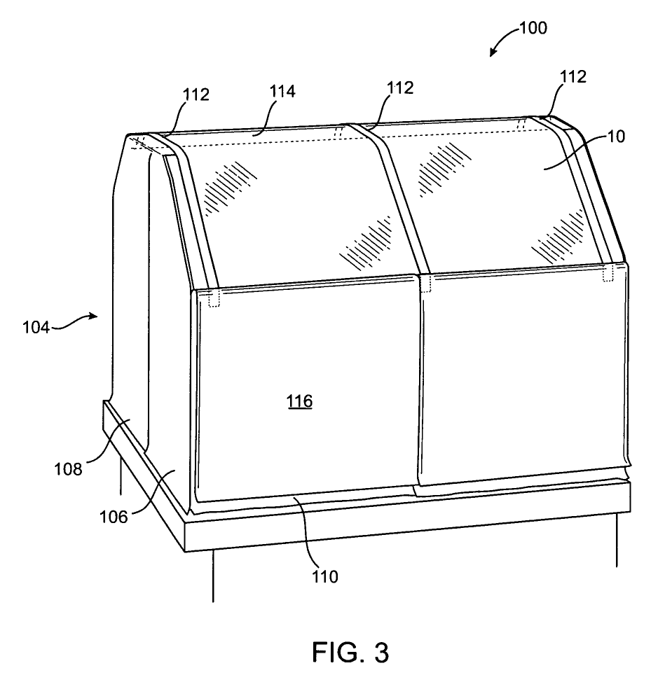

A first example of the incubator cover 100 is shown in FIGS. 1-3. The configuration shown is over an Ohmeda-Ohio Care Plus Incubator 10 manufactured by Ohmeda Medical. The back flap 102 of the incubator cover 100 is approximately 20 inches tall. Two panels form the back flap 102. Each of the two back panels is approximately 17 inches wide. Each of the sides panels 104 of the incubator cover 100 is formed of two panels 106, 108. The front side panel 106 is approximately 22 inches tall and approximately 10.5 inches wide. The rear side panel 108 is approximately 22 inches tall and approximately 11.5 inches wide. Both the front and rear side panels 106, 108 are rounded and shaped to conform to the general shape of the incubator 10. The front panel 110 of the incubator cover 100 is also formed of two panels. Each of the front panels is approximately 34 inches long and 17 inches wide.

Bands or straps 112 may be added that extend across the access opening 114. In Example 1, the incubator cover 100 has three bands or straps 112 across the access opening 114. The bands 112 are added to assist in holding the incubator cover 100 in place and in the proper configuration while the cover panel 116 is removed or folded back to reveal the access opening 114. Although other configurations may be used, in the embodiments shown, the bands 112 extend between the front and back edges of the access opening 114.

One, two, three or more bands 112 may be used depending on the particular configuration of the incubator 10, the configuration of the incubator cover 100 and the access opening 114. The bands 112 are formed of any material that is sturdy enough to hold the incubator cover 100 in place while the cover panel 116 is removed or folded away. Although the bands 112 may be made of a rigid or semi-rigid material, in most cases, the material selected is flexible such that it rests flat against the surface of the incubator 10. For example, the bands 112 may be formed of the same material as the incubator cover 100 or other materials such as twill tape, ribbon, braid, etc. One or both ends may be permanently connected to the incubator cover 100. Alternately, one or both of the ends may be detachably connected to the incubator cover 100.

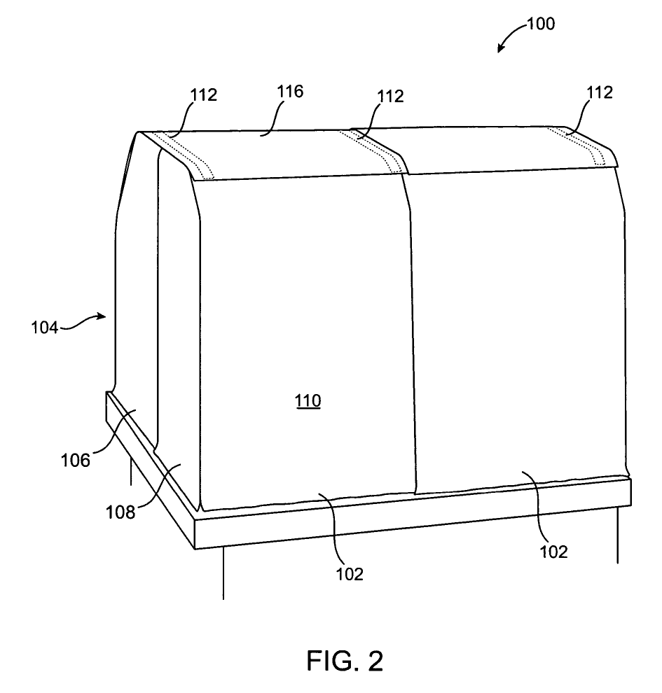

In FIGS. 1 and 2, the three bands 112 are shown in dashed lines to indicate their location beneath the cover panel 116. Each of the side straps 112 are approximately 15 inches in length and the center strap 112 is approximately 17 inches in length. All of the side panels 106, 108 may be fully stitched together or they may be stitched in selected locations to allow the flaps and panels to move apart to allow easier installation over the incubator 10. Once in place, gravity will cause any unsewn flaps to drape and overlap, thereby fully enclosing the incubator 10.

### EXAMPLE 2

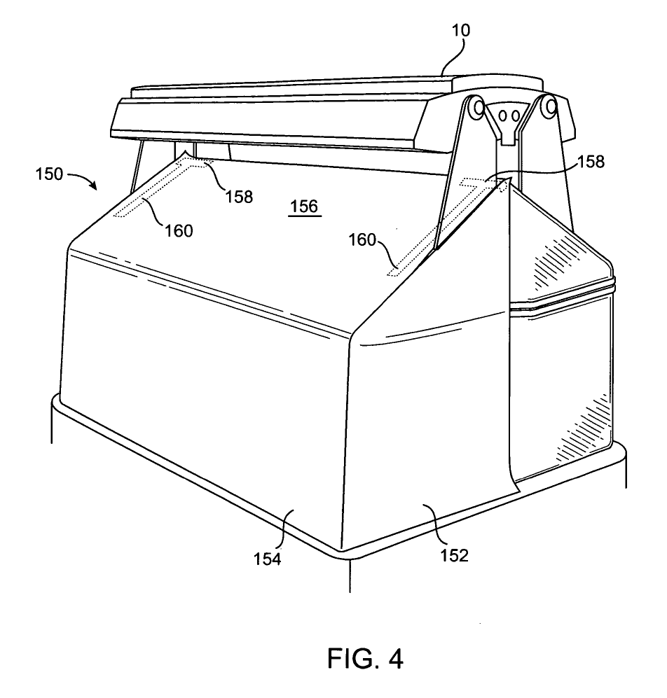

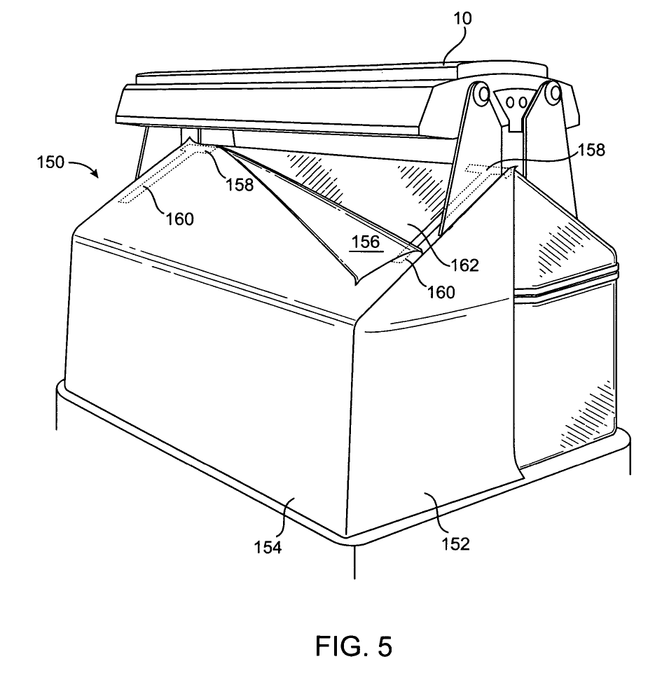

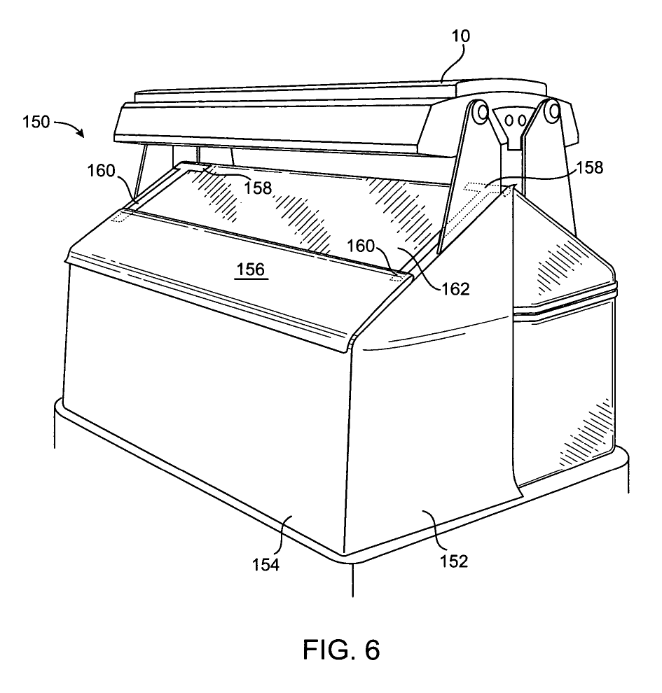

A second example of the incubator cover 150 is shown in FIGS. 4-6. The configuration shown is over a Versalet 7700 Care Center, Model #7700 incubator 10 manufactured by Hill-Rom Air-Shields. In this embodiment, the sides 152 of the incubator cover 150 are approximately 18 inches tall and generally trapezoidal in shape. The base of the side panel 152 is approximately 10.5 inches wide. The front panel 154 of the incubator cover 150 is approximately 34 inches wide and 10.5 inches tall. The cover panel 156, which covers the access opening 162, is approximately 34 inches wide and 14 inches down the inclined top surface of the incubator 10. One two-inch long strip of cloth tape 158 extends from each of the top of the side panel 152. Nine-inch long strips of cloth tape 160 extend from each side of the top of the front panel 154. The pairs of strips 158, 160 are connected together around a portion of the incubator 10 with hook and loop fastener, thereby holding the incubator cover 150 in place. The cover panel 156 is held in place over the access opening 158 by a temporary fastener such as hook and loop fastener, snaps, etc.

### EXAMPLE 3

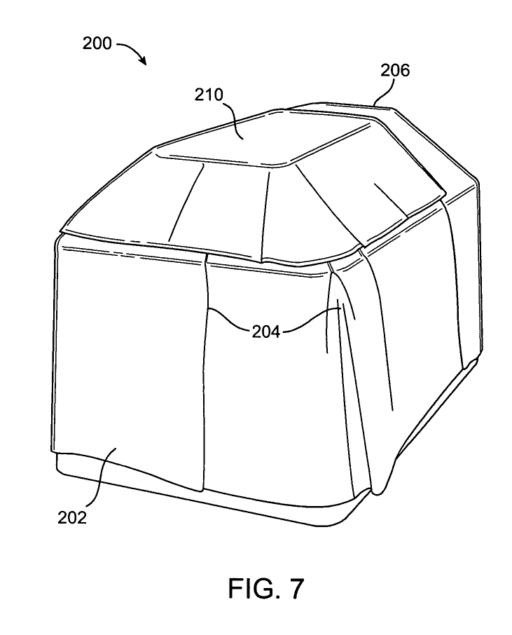

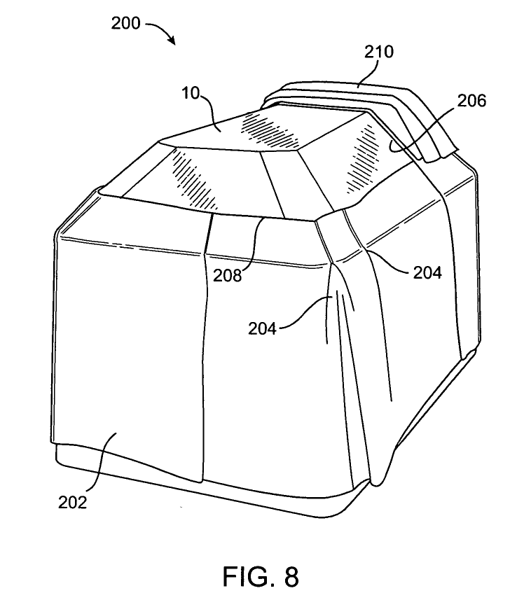

A third example of the incubator cover 200 is shown in FIGS. 7 and 8. The configuration shown is of a third model of infant incubator 10. In this embodiment, the incubator cover 200 takes the form of panels that connect together to wrap around the incubator to form a skirt 202. Along the top edge of the skirt are pleats, darts or other gatherings 204. This reduced diameter section can rest on the sloped sides of the incubator 10, thereby holding the incubator cover 200 in place. An optional partial top panel 206 may be temporarily or permanently added in situations where access to a portion of the incubator 10 is not needed. This leaves an elongated D-shaped opening that forms the access opening 208. In the embodiment shown, the access opening 208 is approximately 20 inches wide by 20 inches tall. The curved end of the D-shape access opening has a width of approximately 16 inches due to the pleats and darts. The skirt 202 of the incubator cover 200 is approximately 18 inches tall. The partial top panel 206 may be approximately 13 to 16 inches wide, as needed. The cover panel 210 fully covers the access opening 208. Although optional, darts are added to the cover panel 210 to fit the cover panel 210 to the shape of the top of the incubator 10.

Although the version show does not include straps, a variation of this embodiment could create the same skirt with or without the gathering and utilize straps to further secure the incubator cover in place.

The figures herein show three versions of the incubator cover 100, 150, 200 designed for particular incubators 10. However, these particular configurations are given as examples only. A different version could be created to suit the specific dimensions and configurations of any particular incubator 10 to be used in conjunction with the incubator cover. In general, the incubator cover would preferably be from 10 to 40 inches tall, more preferably between 12 to 30 inches tall, and most preferably between 15 to 22 inches tall. The incubator cover would preferably be between 20 to 60 inches long, more preferably between 25 and 50 inches long, and most preferably between 30 and 40 inches long. The incubator cover would preferably be between 10 and 30 inches deep, and more preferably between 12 and 25 inches deep. The access opening would preferably be between 10 and 60 inches wide, more preferably between 12 and 50 inches wide, and most preferably between 12 and 40 inches wide. The access opening is preferably between 10 and 50 inches deep, more preferably between 12 and 40 inches deep, and most preferably between 12 and 25 inches deep.

The cover panel that covers the access opening may be designed to be fully detachable or it may be permanently attached. If permanently attached, it may be permanently attached at one or more discreet locations or along one edge, such that the cover panel is folded away from the access opening. The discreet points or entire sides of the rest of the cover panel may have temporary fasteners to hold the cover panel in place over the access opening, and/or the cover panel may rest over the access opening and be held in place by gravity and/or friction. If the cover panel is detachable, a temporary attachment may be used to hold the cover panel in place while it is installed over the access opening. In this case, the temporary attachment may be at one or more discreet locations, such as at the top two or all four corners. Alternately, the top edge, one or both side edges, or all of the edges may be connected with the incubator cover body by temporary fasteners. The unconnected edges may be left free and are held in place by gravity and/or friction.

The general construction of the incubator cover is by attaching panels together to cover the sides and optionally part of the top of the incubator. The side panels may be formed of several pieces that are permanently connected together or they may be held in place only at the top and drape down to cover the incubator. Alternately, the side panels may connect along seams part or all of the distance from top to bottom. An unconnected section toward the bottom, a gusset or other gathering will make installation of the incubator cover easier. The optional top panel may also be permanently connected with the body of the incubator cover.

The incubator cover is formed of one or more sheets of flexible material, such as fabric, plastic, etc. The edges of the access opening may be left raw if the material is not likely to fray, run, or unravel, such as vinyl. For materials that may unravel or fray, the edge of the opening may be enclosed using bias tape, braid, ribbon or other strip type product or otherwise treated to prevent or inhibit fraying and unraveling. Alternately, if the incubator cover is formed of more than one layer, the cover may be turned inside out for sewing, thereby providing a clean edge similar to the edge of a quilt.

The incubator cover may be formed of different types of materials if desired, including dark soothing colors, or bright stimulating patterns. Further the incubator cover may be made reversible to alternately provide the two different environments. For evaluation of infant color, the inside surface may be formed of white or off-white material to provide an environment for good color evaluation. To provide additional sound dampening, a layer of insulation or batting may be also be added. All parts of the incubator cover may be formed of a washable material, including both natural and manmade materials. Natural material include, cotton, cotton blends, linen, etc. Manmade materials include plastics, such as nylon and polyester, vinyl, etc.

The permanent attachments disclosed herein may be formed by sewing, gluing, fusing or otherwise permanently connecting two pieces together. The temporary attachment disclosed herein may be created using hook and loop fastener, snaps, ties, buckles, buttons or other types of temporary attachment mechanisms.

Many features have been listed with particular configurations, options, and embodiments. Any one or more of the features described may be added to or combined with any of the other embodiments or other standard devices to create alternate combinations and embodiments.

Although the examples given include many specificities, they are intended as illustrative of only a few possible embodiments of the invention. Other embodiments and modifications will, no doubt, occur to those skilled in the art. Thus, the examples given should only be interpreted as illustrations of some of the preferred embodiments of the invention.

What is claimed is:

1. An incubator cover for covering an infant incubator containing an infant, comprising:
a flexible incubator cover body;
an access opening formed in said cover body, said access opening located to allow access to an infant located within the infant incubator;
and a cover panel sized and configured to cover said access opening,
wherein said cover panel has an open position and a covering position,
wherein, when said cover panel is in said open position, said access opening is visible,
and wherein, when said cover panel is in said covering position, said cover panel entirely covers said access opening.

2. The incubator cover of claim 1, wherein said cover panel is detachably attached to said incubator cover body.

3. The incubator cover of claim 1, wherein said cover panel is permanently attached to said incubator cover body.

4. The incubator cover of claim 1, further comprising at least one strap configured to rest across a portion of a top surface of said infant incubator, when said incubator cover in installed on the infant incubator.

5. The incubator cover of claim 1, further comprising at least one strap configured to wrap around a portion of the infant incubator, when said incubator cover is installed on the infant incubator.

6. The incubator cover of claim 1, wherein when said cover panel is in said covering position, said cover panel is held in place by gravity and friction.

7. The incubator cover of claim 1, wherein said access opening allows visual access to the infant located within the infant incubator.

8. The incubator cover of claim 1, wherein said access opening allows physical access to the infant located within the infant incubator.

9. The incubator cover of claim 1, wherein said access opening is surrounded by said incubator cover body.

10. In combination:
an incubator;
and an incubator cover including:
a flexible incubator cover body,
an access opening formed in said cover body, said access opening located to allow access to an infant located within the infant incubator,
at least one connector configured to connect said cover body to the infant incubator,
and a cover panel sized and configured to intermittently cover and uncover said access opening.

11. The combination of claim 10, wherein said cover panel is detachably attached to said incubator cover body.

12. The combination of claim 10, wherein said cover panel is permanently attached to said incubator cover body.

13. The combination of claim 10, further comprising at least one strap configured to rest across a portion of a top surface of said infant incubator, when said incubator cover in installed on the infant incubator.

14. The combination of claim 10, further comprising at least one strap configured to wrap around a portion of the infant incubator, when said incubator cover is installed on the infant incubator.

15. The incubator cover of claim 10, wherein said access opening is surrounded by said incubator cover body.

16. A method of treating an infant in an incubator, comprising the steps of:
(a) placing an infant in an incubator;
(b) covering at least an upper portion of the incubator with a flexible incubator cover having a body and a cover panel;
(c) adjusting the cover panel of said incubator cover to reveal an access opening;
(d) and readjusting the cover panel to cover said access opening.

17. The method of claim 16, wherein step (c) is performed by folding the cover panel away from the access opening.

18. The method of claim 16, wherein step (c) is performed by untying at least one strap to allow the cover panel to be folded away from the access opening.

19. The method of claim 16, further comprising the step of visually inspecting the infant.

20. The method of claim 16, further comprising the step of treating the infant.
